(19) United States
(12) Patent Application Publication
(10) Pub. No.: US 2010/0025494 A1
(43) Pub. Date: Feb. 4, 2010

(54) PESTICIDE APPLICATION SYSTEM

(76) Inventor: Jeffrey D. McDonald, Marco Island, FL (US)

Correspondence Address: EDWARD M. LIVINGSTON, PA, 963 TRAIL TERRACE DRIVE, NAPLES, FL, 34103, US

(21) Appl. No.: 12/184,105

(22) Filed: Jul. 31, 2008

(51) Int. Cl. B05B 7/26; B05B 1/00

(52) U.S. Cl. 239/310; 239/589

(57) ABSTRACT

A pesticide application system comprising a dual channeled hose (1) having a first and second channel (2, 3) with a special gun (4) for controlling the flow from either channel (2, 3). The dual channeled hose (1) is stored on a dual supply hose reel (8) having two supply connections (12, 13) for connecting the dual channeled hose (1) to the rest of the pesticide application system. The first channel (2) is connected to a first pump (14) and supplied with ornamental pesticide and the second channel (3) is connected to a second pump (15) and supplied with lawn pesticide. Both pumps (14, 15) are powered by a single motor (16) having two pulleys (17). This invention would allow a user to spray an entire lawn along with the ornamentals at one time thereby reducing the time it takes to apply pesticides to landscaping in half.

### BACKGROUND OF THE INVENTION

This invention relates to pesticides and lawn maintenance, particularly a pesticide application system that allows the user to apply pesticides to a lawn and ornamentals at the same time using the same system.

Currently, commercial pesticide companies use two pesticides in commercial and residential landscaping applications. One pesticide is sprayed on lawns and a second pesticide is sprayed on ornamentals such as bushes and shrubs. The pesticide for ornamentals is usually stronger than the pesticide used on lawns and is normally mixed with oil so it will stick to the leaves of the ornamentals. This requires that a truck or trailer be outfitted with two tanks, two motors, two pumps, two hose reels, two hoses and two spray nozzles. When applying pesticide to a yard, the user must first roll out one hose for the ornamental pesticide, spray all of the shrubs and bushes, and then return to the truck or trailer to roll the hose back up which is a laborious and time consuming task. Next the worker must roll out the second hose for the lawn pesticide, spray the lawn, then roll the second hose back up as well. Due to the time and labor involved in the dual application, often a user who may be tired, lazy, or who just wants to save time, will pull out only one hose and apply the same pesticide to both the lawn and ornamentals, to the detriment of the other.

Thus, a need exists for a pesticide application system which allows the user to apply pesticides to a lawn and ornamentals at the same time using the same system.

The relevant prior art includes the following references:

| U.S. Pat. No. | | |
|---|---|---|
| (U.S. unless stated otherwise) | Inventor | Issue/Publication Date |
| 1. 1,544,509 | Vowell | Jun. 30, 1925 |
| 2. 2,424,468 | Keathley | Jul. 22, 1947 |
| 3. 2,772,921 | Nance | Dec. 04, 1956 |
| 4. 5,152,462 | Evans | Oct. 06, 1992 |
| 5. 5,351,892 | Conte | Oct. 04, 1994 |
| 6. 6,899,282 | Hill | May 31, 2005 |
| 7. 7,044,402 | Finn | May 16, 2006 |
| 8. 7,264,178 | Hugg | Sep. 04, 2007 |

### SUMMARY OF THE INVENTION

The primary objects of the present invention are to provide a pesticide application system which:
reduces the equipment required to apply pesticides to a lawn and ornamentals;
may be outfitted on a smaller truck or trailer;
reduces the time required to apply pesticides to a lawn and ornamentals;
increases the efficiency with which pesticides may be applied to a lawn and ornamentals;
reduces the labor required to apply pesticides to a lawn and ornamentals;
increases the coverage of pesticides on a on a lawn and ornamentals; and
reduces the amount of pesticides wasted when applying pesticides to a lawn and ornamentals.

The present invention accomplishes these and other objectives by providing a a pesticide application system comprising a dual channeled hose having two channels connected to a special gun for applying the pesticide. The gun comprises a handle grip having a trigger for controlling the flow of pesticides from the gun, at least on valve for controlling the flow of pesticides from either channel of the dual channeled hose, and a nozzle that is hinged allowing the user to spray over the top or underneath ornamentals. The nozzle of the gun may also be adjusted to control the size of the stream of pesticides shooting from the gun.

The dual channeled hose is stored on a special dual supply hose reel having two supply connections which connect to the two channels of the dual channeled hose to the rest of the pesticide application system. The first channel of the dual channeled hose is connected to a pump and supplied with concentrated ornamental pesticide mixed with water and the second channel is connected to a second pump and supplied with concentrated lawn pesticide mixed with water. The pesticides are added and mixed to the water by an adjustable dispensing system using a uniform repeating method to insure the proper ratio of pesticide to water. Both pumps are powered by a single motor having two pulleys.

The use of this invention would allow a user to spray an entire lawn along with the ornamentals at one time without having to unroll and roll up two separate hoses thereby reducing the time and work it takes to apply pesticides to landscaping practically in half.

### BRIEF DESCRIPTION OF THE DRAWINGS

In the following detailed description, reference will be made to the attached drawings in which:

FIG. 1 is a top view of the pesticide application system;

FIG. 2 is a front plan view of a dual supply hose reel of the present invention;

FIG. 3 is a perspective top view of a dual channeled hose of the present invention;

FIG. 4 is a side view of the nozzle and the dual channeled hose of the present invention;

FIG. 5 is a side view of the nozzle and the dual channeled hose of the present invention; and

FIG. 6 is a front view of the control valve of the present invention.

### DESCRIPTION OF THE PREFERRED EMBODIMENTS

For purposes of describing the preferred embodiment, the terminology used in reference to the numbered components in the drawings is as follows:

| | |
|---|---|
| 1. | dual channeled hose |
| 2. | first channel |
| 3. | second channel |
| 4. | gun |
| 5. | control valve |
| 6. | nozzle |
| 7. | handle/grip |
| 8. | dual supply hose reel |
| 9. | barrel |
| 10. | base |
| 11. | pass-through hole |
| 12. | first supply |
| | connection |
| 13. | second supply |
| | connection |
| 14. | first pump |
| 15. | second pump |
| 16. | motor |
| 17. | pulley |
| 18. | water reservoir |
| 19. | first additive |
| | reservoir |
| 20. | second additive |
| | reservoir |
| 21. | first supply line |
| 22. | second supply line |
| 23. | injection system |
| 24. | supply valve |
| 25. | hinge |
| 26. | trigger |

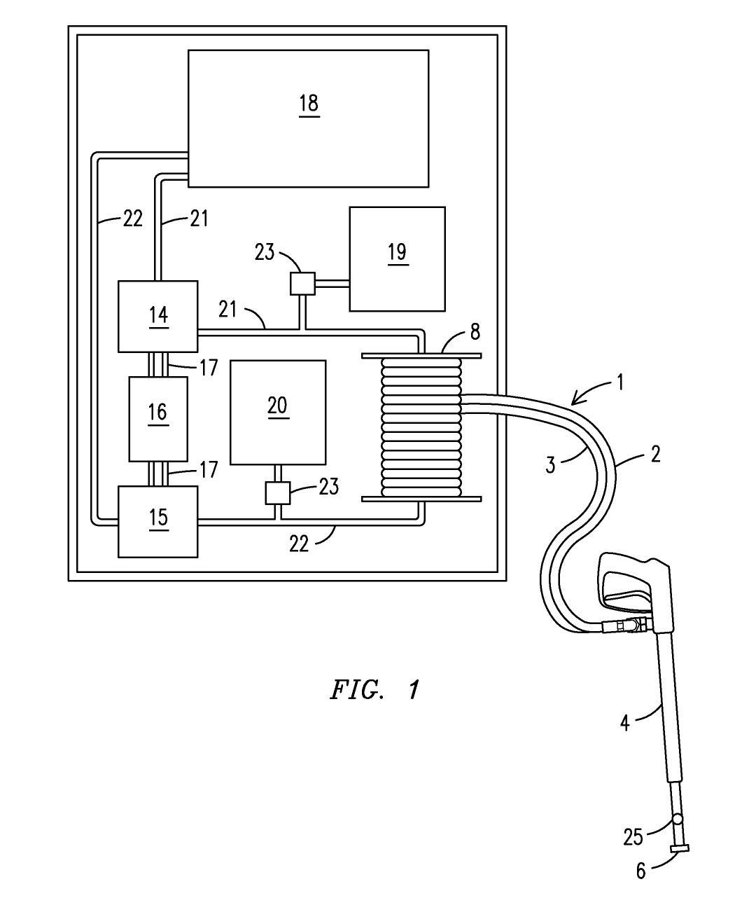

Referring to FIG. 1, a top view of a preferred embodiment of the present invention is shown comprising a dual channeled hose 1, as shown in more detail in FIG. 3, having a first channel 2 and a second channel 3 connected to a gun 4 having at least one control valve 5 for controlling the flow from either the first channel 2 or the second channel 3. The dual channeled hose 1 is stored on a dual supply hose reel 8.

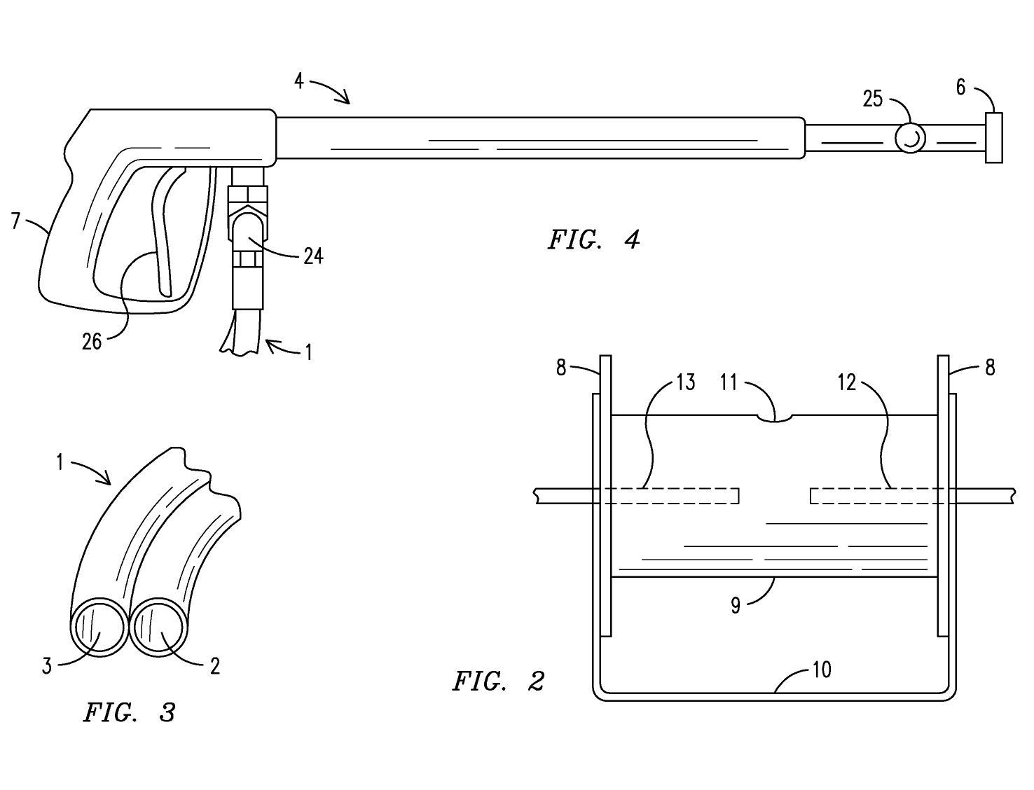

As shown in FIG. 2, the dual supply hose reel 8 comprise a base 10, a barrel 9 which holds the dual channeled hose 1 and a pass through hole 11 which allows the end of the dual channeled hose 1 to be passed through to the center of the barrel 9 where a first supply connection 12 and second supply connection 13 are located. The first supply connection 12 connects the first channel 2 of the dual channeled hose 1 to the other side of the pesticide application system. Similarly, the second supply connection 13 connects the second channel 3 of the dual channeled hose 1 to the other supply side of the pesticide application system.

Referring back to FIG. 1, the first supply connection 12 is connected to a first supply line 21 which is supplied with water from a first pump 14. Similarly, the second supply connection 13 is connected to a second supply line 22 which is supplied with water from a second pump 15. Both the first pump 14 and the second pump 15 are powered by pulleys 17 connected to a single motor 16. The motor 16 of the pesticide application system may be powered by gas, batteries, solar energy, etc.

The first pump 14 and the second pump 15 are connected to a water reservoir 18. When in operation, the first pump 14 and the second pump 15 pump water from the water reservoir 18 through the first and second supply lines 21, 22, the first and second supply connections 12, 13, on through the first and second channels 2, 3 of the dual channeled hose 1 and into the nozzle 4.

A first additive reservoir 19 stores concentrated additives such as pesticides or fertilizers and is connected to the first supply line 12. The contents of the first additive reservoir 19 are added into the water after it has passed through the first pump 14 and before it is supplied to the dual channeled hose 1. Similarly, a second additive reservoir 20 stores concentrated additives such as pesticides or fertilizers and is connected to the second supply line 22. The contents of the second additive reservoir 20 are added into the water after it has passed through the second pump 15 and before it is supplied to the dual channeled hose 1.

The additives may be added to the water in the first and second supply lines 21, 22 through the use of an injection system 23 which dispenses the additives into the water using a uniform repeating method. The injection system 23 may be a venturi system which uses the pressure of the water being pumped through the first and second supply lines 21, 22 to pull small amounts of the additives out of the first and second additive reservoirb 19, 20 and into the water stream. In the alternative, the injection system 23 may inject predetermined amounts of additives into the water stream using a pump to pull the additives out of the first and second additive reservoirs 19, 20.

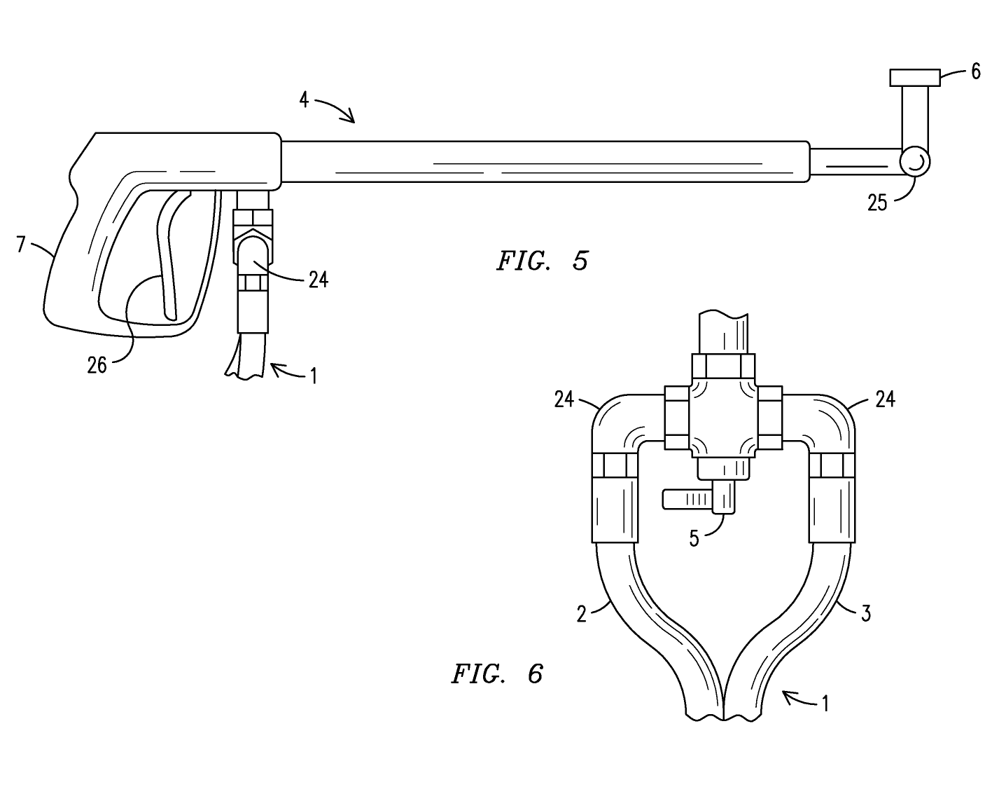

As shown in FIGS. 4 and 5, the pesticides are applied using a gun 4 which is connected to the dual channeled hose 1 via a supply valve 24. The gun 4 comprises a control valve 5, as shown in FIG. 6, to control the flow from the first channel 2 and the second channel 3. The control valve 5 has three settings. The first setting allows flow from only the first channel 2, the second setting allows flow from only the second channel 3, and the third setting shuts off the flow from both the first channel 2 and the second channel 3. In addition, the flow from the gun may be turned on or off by using a trigger 26 mounted on a handle/grip 7.

The gun 4 further comprises a nozzle 6 connected to the gun by a hinge 25 to allow the user to easily spray over the tops or under the bottoms of ornamentals. In addition, the nozzle 6 is adjustable so that the user may adjust the size of the stream being shot from the gun. For example, the user may adjust the stream to a strait stream for spraying ornamentals such as trees which are high up and a long distance from the user. In the alternative, the user may adjust the stream to a full mist for spraying larger areas such as lawns.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A pesticide application system comprising:
a dual channeled hose comprising a first channel and a second channel connected to a gun wherein the gun has means for diverting flow from either channel;
a dual supply hose reel for storing the dual channeled hose;
a water reservoir for storing water;
at least one pump to pump water from the water reservoir to the dual channeled hose;
at least one motor to power the at least one pump;
a first additive reservoir to store additives which are mixed with the water pumped by the at least one pump; and
a second additive reservoir to store additives which are mixed with the water pumped by the at least one pump.

2. The pesticide application system of claim 1 wherein:
the additives stored in the first and second additive reservoirs are pesticides.

3. The pesticide application system of claim 1 wherein:
the additives stored in the first and second additive reservoirs are fertilizers.

4. The pesticide application system of claim 1 wherein:
the additives stored in the first and second additive reservoirs are added to and mixed with the water by an adjustable dispensing system using a uniform repeating method to insure the proper ratio of additive to water.

5. The pesticide application system of claim 4 wherein:
the adjustable dispensing system is a pump.

6. The pesticide application system of claim wherein:
the additives stored in the first and second additive reservoirs are injected and mixed into the water being pumped through the pesticide application system using a venturi system which uses the pressure of the water being pumped to create a vacuum which pulls the additive into the water.

7. The pesticide application system of claim 1 wherein:
the at least one motor is a powered by gas.

8. The pesticide application system of claim 1 wherein:
the at least one motor is powered by electricity.

9. The pesticide application system of claim 1 wherein:
the at least one motor is powered by solar energy.

10. The pesticide application system of claim 1 wherein:
the dual supply hose reel further comprises a base which supports the dual supply hose reel; and
a barrel around which the dual channeled hose is wrapped and stored.

11. The pesticide application system of claim 10 wherein:
the dual supply hose reel further comprises a first supply connection which connects the first channel of the dual channeled hose to the at least one pump; and
the hose reel further comprises a second supply connection which connects the second channel of the dual channeled hose to the at least one pump.

12. The pesticide application system of claim 11 wherein:
the first supply connection and the second supply connection are inside the barrel; and
the barrel further comprises at least one pass-through hole to allow the first channel and second channel of the dual channeled hose to be connected to the first supply connection and the second supply connection.

13. The pesticide application system of claim 1 wherein:
the at least one motor supplies power to the at least one pump using pulleys.

14. The pesticide application system of claim 1 wherein the means in the gun for diverting flow from either channel comprises:
at least one control valve for controlling the flow though the first channel of the dual channeled hose into the nozzle; and
at least one control valve for controlling the flow through the second channel of the dual channeled hose into the nozzle.

15. A pesticide application gun comprising:
at least one supply valve for connecting the gun to a dual channeled hose;
at least one control valve for diverting the flow from either channel of the dual channeled hose; and
a nozzle.

16. The pesticide application gun of claim 15 wherein:
the at least one control valve controls the flow from the first channel of the dual channeled hose;
the at least one control valve controls the flow from the second channel of the dual channeled hose;

17. The pesticide application gun of claim 15 further comprising:
a handle/grip having a trigger for controlling the flow from the nozzle.

18. The pesticide application gun of claim 15 wherein:
the nozzle is attached to the gun by a hinge.

19. The pesticide application gun of claim 15 wherein:
the nozzle may be adjusted to control the size of the stream being shot by the gun.
